(19) United States
(12) Patent Application Publication
(10) Pub. No.: US 2015/0221045 A1
(43) Pub. Date: Aug. 6, 2015

(54) SYSTEM AND METHOD OF NORMALIZING VENDOR DATA

(71) Applicant: Valify, LLC, Frisco, TX (US)

(72) Inventors: Chris Heckler, Frisco, TX (US); Matt Clark, Frisco, TX (US)

(21) Appl. No.: 14/610,791

(22) Filed: Jan. 30, 2015

Related U.S. Application Data
(60) Provisional application No. 61/933,882, filed on Jan. 31, 2014.

(51) Int. Cl. G06Q 40/00

(52) U.S. Cl. CPC G06Q 40/12

(57) ABSTRACT

Aspects of the present disclosure are directed toward systems and methods that include normalizing plurality of unique entries by removing or altering characters from an identification field that delays identification of plurality of unique entries for each of plurality of unique entries. In addition, the systems and methods include associating each of the plurality of unique entries with one of a plurality of vendor entries. Further, the systems and methods include aggregating at least one data field of the plurality of unique entries and normalizing the aggregated data based on at least one other of the multiple data fields. An output is displayed on a user interface.

### CROSS-REFERENCE TO RELATED APPLICATION

This application claims priority to Provisional Application No. 61/933,882, filed Jan. 31, 2014, which is herein incorporated by reference in its entirety.

### TECHNICAL FIELD

The invention relates in general to computerized record-keeping, and in particular to a system and method of analyzing and normalizing accounts payable data for companies of different sizes.

### BACKGROUND

Hospitals are in an environment where both economic and regulatory forces are reducing their top-line revenue. A major focus of hospitals has turned to reducing expenses and/or managing a reasonable return. Group Purchasing Organizations (GPO) aid hospitals in operating more efficiently by pooling purchasing power.

In today's environment the vast majority of product purchases have been commoditized, and GPOs have invested a considerable amount of money in understanding the expenses of the hospital. However, hospitals and GPOs have not yet achieved this level of standardization and cost reduction in the area of purchased services, which comprises the majority of services contracted for in a hospital. Hospitals routinely pay many different service vendors for the same services, duplicating effort and increasing cost. In addition, hospitals pay for many different services, thereby increasing the number of vendors that are retained and paid.

### SUMMARY

Aspects of the present disclosure are directed toward analyzing data from a hospital's accounts payable ledger to reconcile hospital vendor names with known, categorized vendors. In various embodiments, a hospital's total purchased services expenditures are organized into logical groupings to identify opportunities for consolidation. In addition, hospital expenditures can be normalized within each category based on category and hospital-specific metrics. Further, the normalization allows for the analyzing the data versus industry benchmarks which indicate the relative value that hospitals are receiving from their vendors.

In a first example, a system comprising: a first database configured to store a first data set that includes a plurality of vendor entries each having multiple data fields including a vendor identifier; a first circuit configured to receive a second data set that includes a plurality of transaction entries, each transaction entry comprising a plurality of different types of data including a vendor name and a transaction value; control circuitry configured to: normalize each of the plurality of transaction entries to a common format by one or both of removing and altering characters from the vendor name, compare some or all the plurality of transaction entries, as normalized, to some or all of the plurality of vendor entries, respectively; for each comparison, determine a degree of matching based at least in part on one or more similarities between the vendor identifier of the vendor entry and the vendor name as normalized; categorize the plurality of transaction entries into a plurality of groups based on the respective degrees of matching between the transaction entries and the vendor entries, the plurality of groups corresponding to the plurality of vendor entries, respectively; and for each of the plurality of groups, aggregate the transaction values for all transaction entries within the group; and a user interface configured to display a listing of the plurality of groups and the respective aggregated transaction value of each group.

In example 2, the system of example 1, wherein the control circuitry is further configured to determine the degree of matching by applying multiple algorithms to each of the transaction entry and the vendor entry that are compared, each algorithm assessing, by a different metric, whether the transaction entry, as normalized, and the vendor entry relate to the same vendor.

In example 3, the system of example 2, wherein each of the multiple algorithms outputs a vote and the votes of the multiple algorithms are aggregated to determine a degree of matching.

In example 4, the system of example 3, wherein the control circuitry is further configured to determine, for each transaction entry, a highest degree of matching between the transaction entry and multiple of the vendor entries, and wherein the control circuitry is configured to categorize the transaction entry into the group of the multiple groups that is associated with the vendor entry with which the transaction entry has the highest degree of matching.

In example 5, the system of any of examples 1-4, wherein each group of the multiple groups is associated with a single, respective vendor of a plurality of vendors.

In example 6, the system of any of examples 1-5, wherein multiple of the transaction entries are categorized into each of the multiple groups.

In example 7, the system of any of examples 1-6 wherein the plurality of different types of data of the transaction entries comprise indications of a plurality of different types of services and the plurality of vendor entries comprises indications of the plurality of different types of services, wherein the control circuitry is configured to determine the degree of matching based at least in part on matching or non-matching between the indications of the plurality of different types of services between each of the transaction entry and the vendor entry that are compared.

In example 8, the system of any of examples 1-7, wherein the control circuitry is configured to aggregate the transaction values for all transaction entries within each group by calculating a transaction average per at least one of number of beds, average daily census, average daily admissions, number of surgical beds, number of emergency room beds, and square feet of the hospital.

In example 9, the system of any of examples 1-8, wherein the control circuitry is further configured to: define a plurality of subgroups, the plurality of subgroups respectively associated with a plurality of signatures, each of the plurality of signatures indicative of one or both of a respective type of service and a particular vendor name characteristic; for each of the plurality of transaction entries, assign the transaction entry to one of the plurality of subgroups based on a similarity between at least one of the plurality of different types of data of the transaction entry and the signature associated with the subgroup; for each of the plurality of vendor entries, assign the vendor entry to one of the plurality of subgroups based on a similarity between the vendor identifier of the vendor entry and the signature associated with the subgroup; and compare some or all the plurality of transaction entries to some or all of the plurality of vendor entries, respectively, by only comparing those transaction entries to those vendor entries which are assigned to the same subgroup.

In example 10, the system of example 9, wherein the control circuitry is distributed amongst a plurality of discrete computers each having a respective processor, the subgroups are respectively mapped to the plurality of discrete computers, and the control circuitry is configured to perform the comparing step such that each computer of the plurality of discrete computers performs the comparison only between those transaction entries and vendor entries of the subgroup mapped to the computer.

In example 11, a system comprising: a first database configured to store a first data set that includes a plurality of vendor entries each having multiple data fields including a vendor identifier; a first circuit configured to receive a second data set that includes a plurality of transaction entries, each transaction entry comprising a plurality of different types of data including a vendor name and a transaction value; and control circuitry. The control circuitry can be configured to define a plurality of subgroups, the plurality of subgroups respectively associated with a plurality of signatures, each of the plurality of signatures indicative of one or both of a respective type of service and a particular vendor name characteristic; for each of the plurality of transaction entries, assign the transaction entry to one of the plurality of subgroups based on a similarity between at least one of the plurality of different types of data of the transaction entry and the signature associated with the subgroup; for each of the plurality of vendor entries, assign the vendor entry to one of the plurality of subgroups based on a similarity between the vendor identifier of the vendor entry and the signature associated with the subgroup; for each subgroup, compare the transaction entries assigned to the subgroup to the vendor entries assigned to the subgroup; for each comparison, determine a degree of matching between the vendor identifier of the vendor entry and the vendor name of the transaction entry; categorize the plurality of transaction entries into a plurality of groups based on the respective degrees of matching between the transaction entries and the vendor entries, the plurality of groups corresponding to the plurality of vendor entries, respectively, and for each of the plurality of groups, aggregate the transaction values for all transaction entries within the group. The system can further include a user interface configured to display a listing of the plurality of groups and the respective aggregated transaction value of each group. The control circuitry can be distributed amongst a plurality of discrete computers each having a respective processor, the subgroups can be respectively mapped to the plurality of discrete computers, and the control circuitry can be configured to perform the comparing step such that each computer of the plurality of discrete computers performs the comparison only between those transaction entries and vendor entries of the subgroup mapped to the computer.

Further features and modifications of the various embodiments are further discussed herein and shown in the drawings. While multiple embodiments are disclosed, still other embodiments of the present disclosure will become apparent to those skilled in the art from the following detailed description, which shows and describes illustrative embodiments of this disclosure. Accordingly, the drawings and detailed description are to be regarded as illustrative in nature and not restrictive.

### BRIEF DESCRIPTION OF THE DRAWINGS

FIG. 1 shows an example flowchart representing a process for analyzing and normalizing accounts payable data, consistent with various aspects of the present disclosure;

FIG. 2 shows an example flowchart representing a process for normalization of vendor names, consistent with various aspects of the present disclosure;

FIGS. 3a and 3b show example flowcharts representing a process that illustrates the matching of vendors, consistent with various aspects of the present disclosure;

FIG. 4 shows a sample output from algorithms of the present disclosure; and

FIG. 5 shows an example conceptualized drawing illustrating a computer connected to the internet and optionally connected to other computers for use with the process and for storing instructions, consistent with various aspects of the present disclosure.

While multiple embodiments are disclosed, still other embodiments within the scope of the present disclosure will become apparent to those skilled in the art from the following detailed description, which shows and describes illustrative embodiments. Accordingly, the drawings and detailed description are to be regarded as illustrative in nature and not restrictive.

### DETAILED DESCRIPTION

One avenue to address hospital costs is identifying multiple services from common vendors and consolidating vendors so as to offer a select few vendors higher quantities of business in order to obtain price concessions. For example, one vendor may provide multiple instances of the same type of service to different parts of the same hospital in transactions that are overseen by different administrators. Further, one vendor may provide different types of services to the same or different parts of the same hospital. Being that a hospital and/or a GPO often have thousands of services provided to them, efficiently grouping, normalizing, and efficiently analyzing the services becomes impossible for a human to carry out. Hospitals and GPOs have not established the capability of identifying these opportunities for vendor consolidation in the purchased services market. These and other issues are addressed by embodiments of the present disclosure, as further discussed herein.

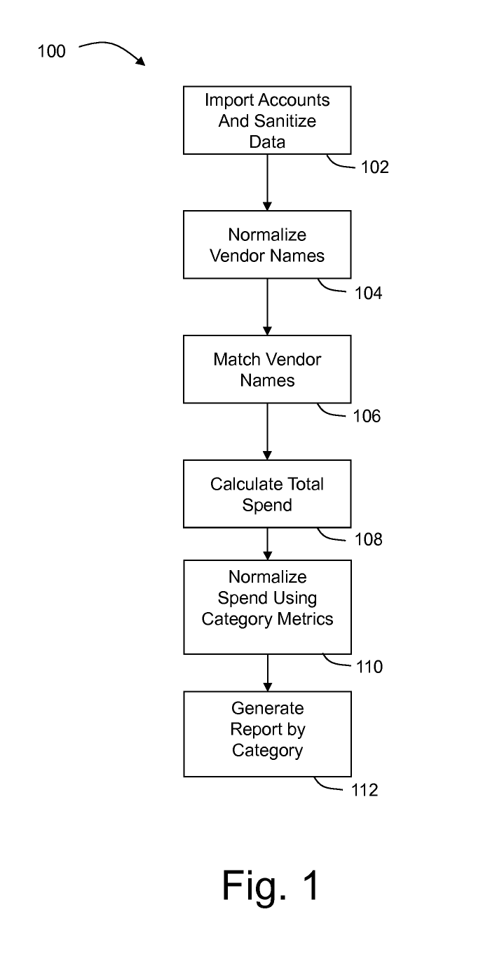

FIG. 1 shows an example flowchart representing a process for analyzing and normalizing accounts payable data, consistent with various aspects of the present disclosure. As is shown at block 102, a set of data including a plurality of transaction entries is imported or received, for instance, in comma-separated values (CSV) format. Each transaction entry can represent a single transaction between the hospital and a vendor, and can be extracted from account payable invoices. Each transaction entry includes multiple types of data such as the date, vendor name, brief description of the type of service (e.g., cleaning, food), and/or amount due/paid recorded as a single continuous line or string of characters (e.g., letters, numbers, and symbols). Such a string can be, for example, “19992,2014-1-8,Internet service,G0876,$5960.7,Grande Communications. The data with the single string can be parsed out based on specific details to create a data set of distinct data elements, such that the data set no longer appears as single string. For example, a vendor name is identified and separated from the string. Likewise, monetary amounts, dates, vendor ID numbers, and basic descriptions of types of services are also separately identified as elements of the data set. Separating the data in this manner may be useful because different filtering steps are performed on the different elements of each data set of each transaction entry. More specifically, the number 19992 can represent a general ledger (GL) account. Additional information such as the GL description may be recorded for manual use or for future algorithms. The accounts payable data that is imported or received can be imported in other formats as well. These other data formats similarly include a plurality of transaction entries, with each entry typically including a vendor name, data, amount, general ledger account number, general ledger description, and account description. The plurality of transaction entries can include data related to a hospital's spending, such as an export of P-card data (records of purchases made on a purchasing card, or credit card), spreadsheets, or even raw invoices.

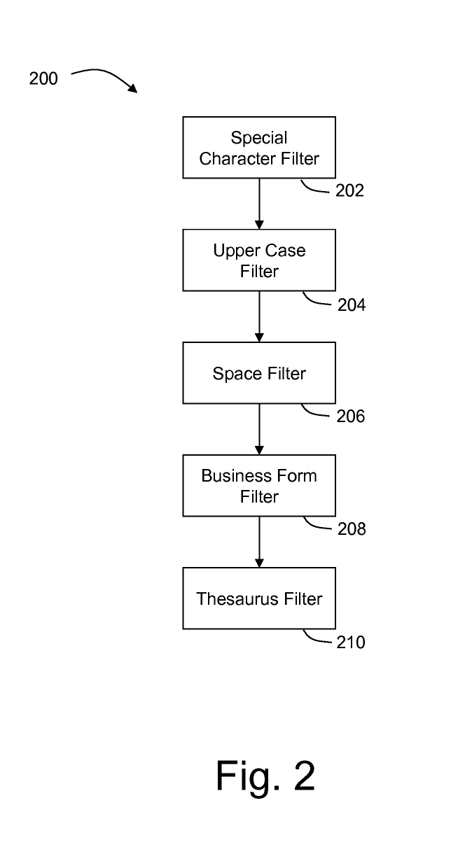

As is shown at block 104, the imported data is normalized, which can be performed in the manner shown and described with reference to FIG. 2 below. For instance, in certain embodiments, the process of filtering and normalizing the vendor names includes normalizing each of the plurality of transaction entries to a common format by one or both of removing and altering characters from the vendor name for easy matching to the vendor entries of known vendors which can likewise for formatted to the common format.

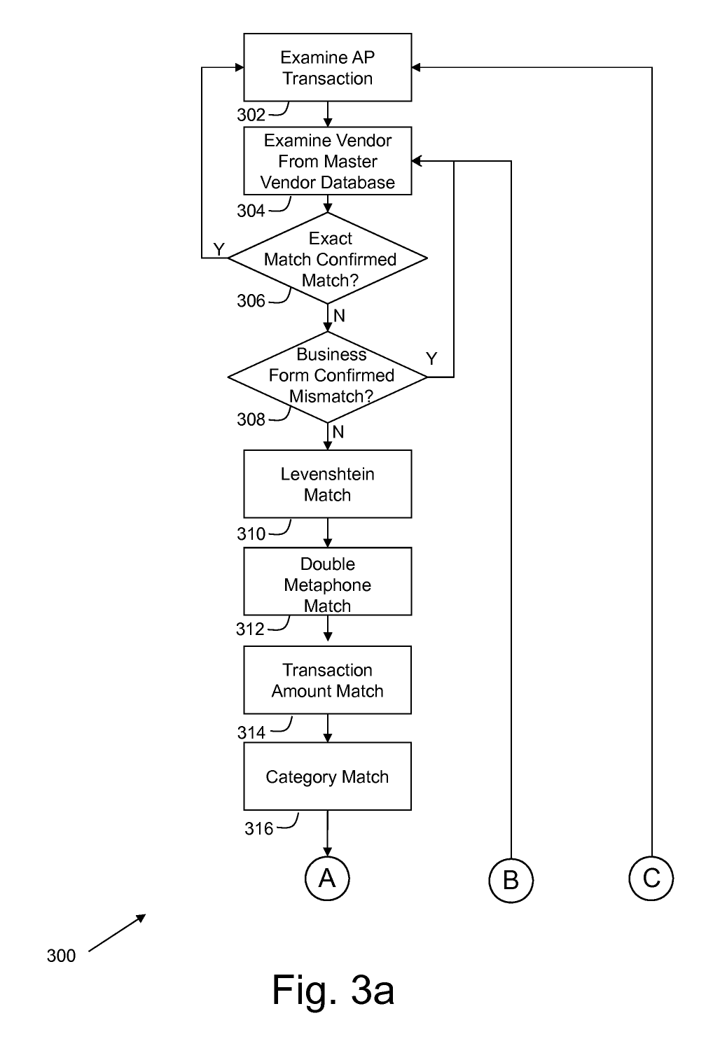

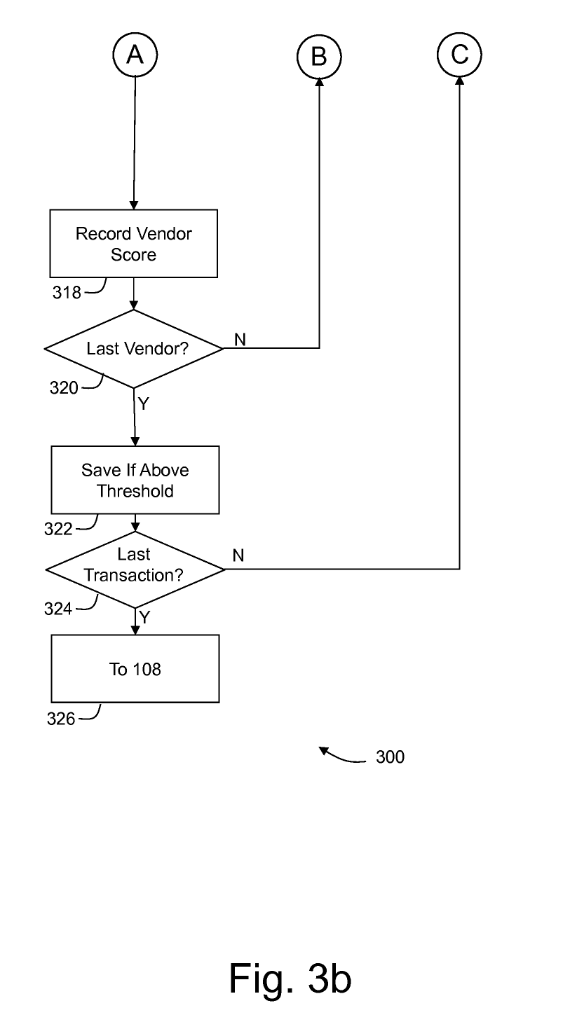

As is shown at block 106, some or all of the plurality of transaction entries of the imported data, as normalized at block 104, are compared to some or all of the plurality of vendor entries which can be performed in the manner shown and described with reference to FIG. 3 below. The plurality of vendor entries can represent a listing of vendors known to conduct business with the hospital, GPO, or otherwise confirmed to be in business. The names of the plurality of vendor entries can be normalized in the same manner as discussed herein for the plurality of transaction entries, such as in the manner of block 104.

Returning to block 106, a comparison is made between the normalized names (or other information) of some or all the plurality of transaction entries to some or all of the plurality of vendor entries, respectively. A plurality of vendor identifiers can be respectively associated with the plurality of vendor entries, each vendor identifier identifying a respective known vendor. A vendor identifier can be, for example, a normalized name of the vendor, the name normalized in the same manner as the vendor names of the plurality of transaction entries as described herein. For each comparison, a degree of matching is determined based at least in part on one or more similarities between the vendor identifier of the vendor entry and the vendor name, as normalized, of the transaction entry. As will be discussed later herein, the plurality of transaction entries are categorized into a plurality of groups based on the respective degrees of matching between the transaction entries and the vendor entries.

It is noted that these comparisons involve a large transactional record with thousands of vendor names, and a database of known vendors with hundreds of thousands of names. A plurality of transaction entries can include over 1,000,000 rows that need to be processed. In certain embodiments, at block 104 and as described in further detail below, a looped approach is applied in comparing some or all the plurality of transaction entries to some or all of the plurality of vendor entries. More specifically, each of the plurality of transaction entries included are analyzed to determine if each of a degree of matching between the known vendors and any alternate names of the plurality of vendor entries. Each of the plurality of transaction entries is evaluated to determine if the vendor identifier is sufficiently similar to the vendor name to classify as a match. This is a combinatorial problem, which can grow exponentially as the size of the accounts payable batches and the vendor database grow. As an example, to test 500,000 rows against 500,000 vendors the system would need to perform 250,000,000,000 evaluations, each consisting of many algorithms. If the AP batch grows to 1,000,000 rows and the vendor database including alternate names includes 600,000 names, the number of combinations is 600,000,000,000 evaluations. This volume of processing can take a prohibitively long time to perform when done serially on a single server, so it may be necessary both to distribute the processing and divide the processing up into smaller blocks in order to reduce the combinatorial nature of the problem. Row de-duplication and map/reduce algorithms can be run to decrease the number of comparisons that been to be made, each of which are further discussed herein.

Further as part of matching at block 106, a plurality of groups can be formed linking one or more transaction entries with a particular one of the groups, each group of the plurality of groups representing a different one of the vendor entries. In this way, the plurality of transaction entries are categorized into the plurality of groups based on the respective degrees of matching between the transaction entries and the vendor entries. A particular group, corresponding to one of vendors, may contain one transaction entry (meaning that only one transaction was conducted with that vendor). A different group, corresponding to another one of vendors, may contain multiple transaction entries (meaning that multiple transactions were conducted with that vendor).

As is shown at block 108, transaction values for all transaction entries within each of the plurality of groups are aggregated for each vendor and category. A listing of the plurality of groups and the respective aggregated transaction value of each group can be displayed on a user interface. For example, group, corresponding to one of vendors, may contain twenty transaction entries. The transaction values for the twenty transaction entries can be added to determine a total spend value with that vendor and further divided by the number of transaction to determine an average transaction value and/or divided by the number of beds in the hospital (e.g., to determine the cost of doing business with the vendor on a per/bed basis). In various embodiments, it may be valuable not only to identify opportunities for vendor consolidation, but also to understand how the amount spent in a given category compares with industry averages. For example, in the case of hospitals, hospital A might spend $20,000 per month on housekeeping services and hospital B might spend $30,000 per month in housekeeping services. This comparison alone may be a misleading basis for comparison because hospital A has 100 beds and hospital B has 200 beds. Thus, while hospital A spends less in total, it spends $200 per bed per month while hospital B spends $150 per bed per month. In addition, in various embodiments, metrics may be recorded which vary by category, such as the number of beds, average daily census, average daily admissions, number of surgical beds, number of ER beds, or square feet. The system provides more value to the end user of the reports by providing these normalized transaction values in addition to the total spend.

After the transaction values for all transaction entries are normalized relative to the spend amount in each group, an overall or specific analysis of category spend versus industry benchmarks may be provided, as is shown at block 112. Further, in various embodiments, the normalized transaction values for all transaction entries are compared with benchmarks from other clients, such as hospitals or GPOs in the industry. The final report that is displayed on a user interface can include indications as to whether the client spends more or less for the same services as other comparable clients.

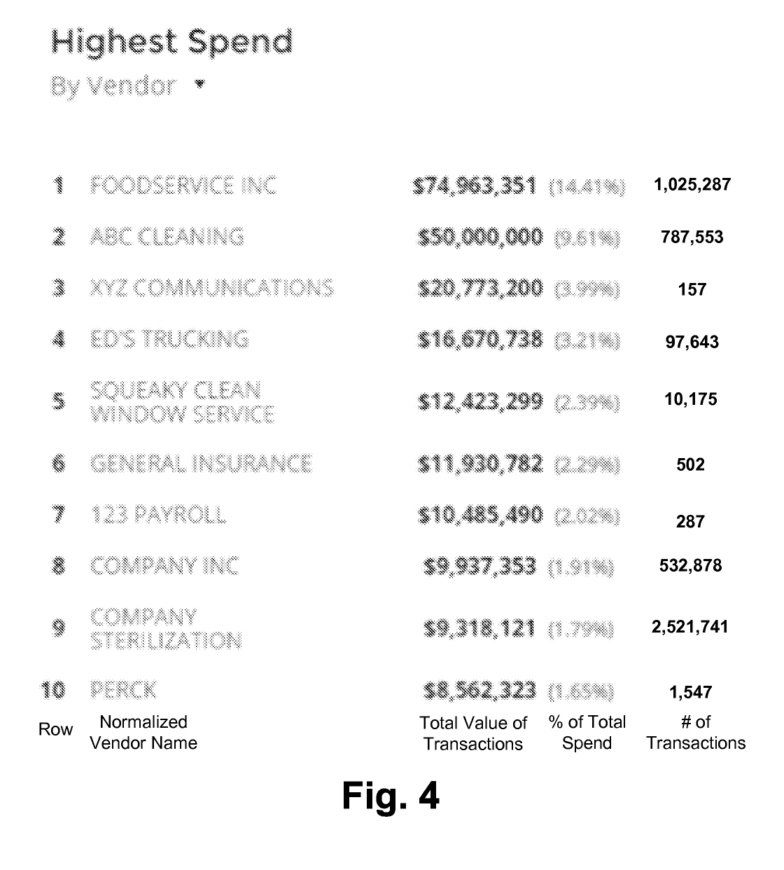

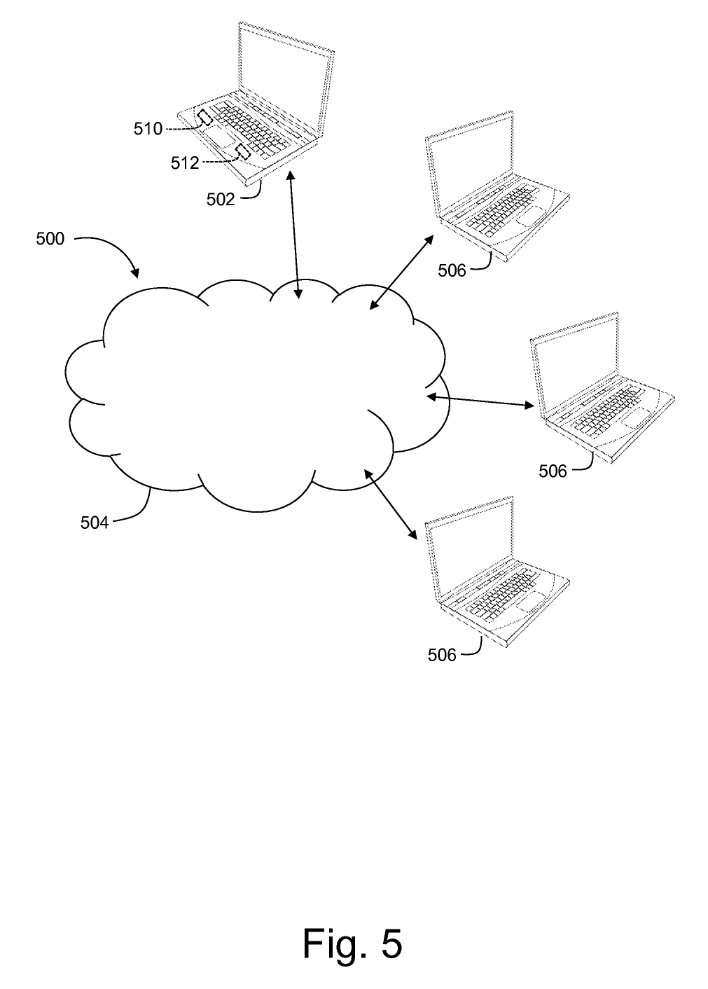

This analysis or report may be provided to a user in report form and emailed to the clients, or obtained via standard web browsers using computer devices (e.g., including a screen to display any information referenced herein) coupled to the internet where the reports database may be stored on a server, as illustrated in FIGS. 4 and 5. In various embodiments, such reports may be obtained as a web service. Similarly, the importation of accounts payable data may be accomplished via an internet connected computer network as illustrated in FIG. 4.

FIG. 2 shows an example flowchart representing a process for normalization of vendor names, consistent with various aspects of the present disclosure. The example process 200 can coincide with block 104 of the process shown in FIG. 1 for normalization of vendor names. The process 200 can be carried out on a plurality of transaction entries imported via step 102, each entry including a non-normalized vendor name amongst the plurality of transaction entries. As is shown in FIG. 2, in various embodiments, a given vendor name may have, for instance, 10 or more variations that an accounts payable (“AP”) accountant may use when journalizing a transaction. For example, “FoodService” may be listed as “FOODSERVICE”, “FOODSREVICE”, “FOODSERVICE Inc.”, “FOOD SERVICE”, or “Food Service.” In order to improve the likelihood of finding a correct match, filters may be applied to the vendor names to normalize them. The end result is a normalized string which may be used as the basis for comparisons to a known set of normalized vendor names.

In various embodiments the process of filtering and normalizing the vendor names also includes applying a special character filter process to eliminate special characters, as is shown at block 202, such as an asterisk (*) or a pound sign (#) which may sometimes appear in the transactional record as a note to the accounting staff, and/or sometimes as a part of a business's name. These characters generally do not aid in recognition of the name, and in various embodiments may be removed from the string that will eventually be used for comparison to known vendors. In some cases, special characters filter eliminates all non-letter (e.g., a-z) and non-number (e.g., 0-9) characters. Special characters may be commonly included either through typographical errors when typing the name, through the translation of brand marks into text, or through common optional abbreviation marks. These characters typically do not add any informational value to the name but may inhibit accurate matching later if included only in some representations of the name. These characters can include: * (asterisk), . (period), # (pound), $ (dollar sign), % (percent sign), ̂(carat), ' (apostrophe), ? (question mark), and | (pipe). Additional characters which may be filtered out include: \ (backslash), - (hyphen), ((left parenthesis), ) (right parenthesis), @ (at sign), ; (semicolon), : (colon), + (plus sign), = (equals sign), _ (underscore), [ (left bracket),] (right bracket), { (left brace),} (right brace). These characters are replaced with a single space, as these characters commonly separate two words, and removing them without inserting a space would combine two words which should not otherwise be combined.

As is shown at block 204, the process of filtering and normalizing the vendor names can also include processing upper case letters. In this step, the names may be converted to all upper-case letters to reduce the impact of typographical errors or multiple versions of a company's name.

As is shown at block 206, the process of filtering and normalizing the vendor names can also include filtering spaces in vendor names. Typographical errors can result in a leading space, a trailing space, or a series of two or more consecutive spaces appearing within a name. Leading and trailing spaces may then be removed and/or multiple spaces are combined into one space.

As is shown in block 208, the process of filtering and normalizing the vendor names can also include processing the form of the vendor name. In this step, a vendor name may include different indications of the legal form of business (e.g., the type of legal construct under which the business is formed, such as Inc., LLC, PC, etc.). In certain embodiments, any indicator of the legal form of business is extracted from the vendor name, leaving behind only the significant portion of the name. For example, “FoodService Inc.” indicates that FoodService is a C-corp. Since this portion of the vendor name may or may not be entered, the system may prune the text “Inc.” from the string, but may record the information for later use. In an example “COMPANY, INC.”, the token “INC.” is an indicator that the company has incorporated, but it is not significant in differentiating two different business names. The “COMPANY” token is significant, and should be the basis for comparison. Once the form of business has been removed from the vendor name, it can be beneficial to record the form of business along with the name as a separate record. This can be used in a business form matching strategy to disqualify matches where the significant portion of the vendor name matches, but the form of business does not match.

As is shown at block 210, the process of filtering and normalizing the vendor names can also include converting common abbreviations, misspellings, and alternative word forms of a vendor name into one common word form. One example is the word “SERVICE”, which can alternately appear as “SERVICES”, “SVC, “SVCS”, “SRVC”, or “SERV”. Additionally, it can be misspelled as “SEVRICE”, and many other variations. These misspelled or incorrectly identified terms are all converted to the same word “SERVICES”. While later algorithms could potentially recognize these variations as one common word, applying this processing reduces the number of errors and increases the probability of a match. This operation may also occur on a portion of a vendor name that includes a sequence of characters that are significant as a group. For instance, the sequence of characters “COMM” is converted to “COMMUNICATIONS”, allowing for a more accurate comparison to the vendor name that includes “COMMUNICATIONS”.

As shown at block 208, the process of filtering and normalizing the vendor names can also include extracting number sequences from the vendor name that are not useful in identifying the vendor. More specifically, one class of these vendor names are businesses which have a legal name that includes a sequence of numbers, but for which the spending should be aggregated under the trade name. One example of this class is “COMPANY 211 INC”, which should be more accurately represented as, “COMPANY INC”. Another class of these vendor names is a business which has multiple physical locations or stores which are carry a numeric designation such as “COMPANY CORPORATION 447”. Yet another class of these names is names in the plurality of transaction entries which contain a sequence of numbers that hold some significance to the accounting department, but which are not part of the legal or trade name of the business. One example of this class is “COMPANY STERILIZATION 69464”, where “69464” is most likely a file number internal to the hospital's accounting department. However, sequences of numbers that start the vendor name are not removed due the fact that businesses like “123 COMPANY INC” commonly start their trade names with numerical sequences that are meant to differentiate them from other businesses. More specifically, a regular expression, which is a sequence of characters interpreted by a regular expression library to control how to match various sequences of characters, is used to identify these number sequences. The specific regular expression used “[̂\̂]\d\d+” accomplishes the goals; however the goals of this filter could be accomplished through alternative means, or even alternative regular expressions.

It is noted that the steps of the process 200 may be performed in a different order than that shown. Also, one or more of the indicated steps may not be performed and/or additional steps may be performed in various embodiments. In various embodiments, the process 200 then returns to the process as shown in FIG. 1 where the next step is performed (e.g., step 106).

FIGS. 3a and 3b show example flowcharts representing a process that illustrates the matching of vendors, consistent with various aspects of the present disclosure. The process 300 shown in FIG. 3 (which can coincide with block 106 of FIG. 1) illustrates one embodiment of the matching of vendors.

More specifically, each of the plurality of transaction entries (e.g., now having a normalized vendor name) may be inspected individually (as is shown in blocks 302 to 324) using a set of matching algorithms to attempt to match some or all the plurality of transaction entries to some or all of the plurality of vendor entries. Each of the plurality of vendor entries can include data elements corresponding to each of the plurality of transaction entries as normalized in connection with step 104. For each of the plurality of transaction entries, the system loops through some or all the plurality of transaction entries (as shown in blocks 304 to 320) using the matching algorithms to compare the plurality of transaction entries to the plurality of vendor entries. The database that stores the plurality of vendor entries can include a list of vendors previously confirmed to be working with the particular hospital or GPO, or a list of vendors previously confirmed to be in operation, and each vendor entry in the known vendor can be normalized in the same manner as with step 104.

In certain embodiments, the matching algorithms are applied in series, and each quantifies or “votes” on the likelihood that the plurality of transaction entries matches one or more of the plurality of vendor entries. In various embodiments, each matching algorithm has the opportunity to register a vote from 0 to 100, with 0 indicating a matching certainty; 100 indicating absolute certainty, and any number in between registering a vote on the probability of matching. Other ranges and values are possible.

In various embodiments, the matching algorithm may also abstain from voting if its algorithm cannot be applied to the vendors for a specific reason. If a matching algorithm registers a 0 or a 100, the vote stops and the candidate is either dismissed or accepted, respectively. If no matching algorithm registers a certain vote, a weighted average of the votes is constructed and recorded as the probability of a match (as is shown at block 318). After investigating all potential matches from the database storing the plurality of vendor entries (as is shown at block 320), if no certain match has been found then the highest scoring vote is compared to a threshold, such as a 90% confidence. If the best candidate match exceeds 90% (block 322), then it is accepted as a match. In various embodiments, such comparisons may involve a large transactional record with thousands of names for an equal number of transaction entries, and a database including known vendor names. The database can include hundreds of thousands of known vendor names.

In certain embodiments, the database of known vendor names, corresponding to the plurality of vendor entries, also includes alternate names, categories, and transactions. In addition, a known vendors table includes information for each vendor, an internal unique identifier, a vendor name, and a category. It may also include a persistent copy of the normalized name, however this may also be calculated from the vendor name on a just-in-time basis as is done in the current embodiment. The database of alternate names includes a unique identifier, a reference to the associated primary vendor record, a name, and a normalized name. The alternate names increase the likelihood of a match for companies which may have multiple trade names, common misspellings, or various ways in which the trade name may be represented. Categories are hierarchically arranged; however vendors are associated with one primary category.

In various embodiments, an addition step, as is shown at block 306, an exact match process is used in comparing some or all the plurality of transaction entries to some or all of the plurality of vendor entries. More specifically, the plurality of transaction entries before and after normalization are compared the plurality of vendor entries. As noted above, known vendor names and alternate vendor names are stored in a database. The exact match process tests for an exact match against those variations. If an exact match is found the process resumes at block 302. Otherwise, this sub-process may abstain from voting. In addition, a business form match can be utilized, as is shown at block 308. This strategy examines the form of business of the vendor in the transaction and the candidate vendor from the master database. If both names include a form of business and they do not match (e.g., Inc. vs. LLC), this algorithm returns 0. If both names include a form of business and they do match (e.g., Inc. vs. Inc.), this algorithm returns a predetermined value, such as 75. If either of the names does not include a form of business, this strategy may abstain from voting. If a confirmed mismatch is determined, the process resumes at block 304. Otherwise, the process continues at block 310.

As is shown at block 310, a Levenshtein match process is used in comparing some or all the plurality of transaction entries to some or all of the plurality of vendor entries. A Levenshtein algorithm is an “edit distance” algorithm for comparing textual strings. The algorithm computes the minimum number of character edits that would need to be made in order to transform one string into the other. This algorithm calculates the edit distance, and then calculates the probability of a match by dividing the edit distance by the length of the longer of two names being compared. A threshold may be used for identifying matches from this step, such as a number representing the maximum number of character edits between the plurality of transaction entires as normalized and a vendor name of the database, which the algorithm would vote for a match and which the algorithm would abstain or vote against. This probability may be returned as the vote for this strategy. The process then continues at block 312.

As is shown at block 312, a double metaphone match process is used in comparing some or all the plurality of transaction entries to some or all of the plurality of vendor entries. The double metaphone identifies homophonic sounds in the English language and normalizes them into what can be described as phonetic strings. As an example, the word “McLesson” becomes “MLSN”, and the word “Perck” becomes “PRK”. The names may be run through this algorithm using a maximum code length (e.g., 1 0), and then a Levenshtein edit distance is taken to calculate a percentage difference between the two double metaphone codes. A threshold may be used for identifying matches from this step, such as a percentage difference below which the algorithm would vote against a match or abstain and above which the algorithm would vote for a match. This percentage is returned as the vote for this step.

The process then continues at block 314. As is shown at block 314, a transaction amount match sub-process is used in comparing some or all the plurality of transaction entries to some or all of the plurality of vendor entries. In such a process, the mean and/or standard deviation of transactions historically allocated to specific vendors in the vendor database are used to identify whether or not one of the plurality of transaction entries, as normalized, matches the normal transactions allocated to the vendor. A statistical comparison, such as a T-test, may be run to determine whether the mean and standard deviation of the AP transaction values for the candidate vendor differ from the known transaction mean and/or standard deviation for this vendor. If the difference is greater than could be caused by chance, this algorithm may vote 0, or a certain mismatch. Otherwise, this algorithm may abstain from voting. Other statistical comparisons may be made to determine whether transactions attributed to the vendor match the normal distribution of amounts from the known vendor. More specifically, if the amount falls outside of 3 standard deviations then the algorithm abstains from voting. This last decision was made because a vote of 68.3 (the percentage that should fall within one standard deviation if they are a match) would artificially drag the score down, and giving a higher percentage would be statistically inaccurate. The process continues at block 316.

As is shown at block 316, a category match process in comparing some or all the plurality of transaction entries to some or all of the plurality of vendor entries. This step helps indicate matches between the plurality of transaction entries and vendor names from the known vendor database based on names for the categories of services associated with each of the transaction entries and the known vendor database. Examples of categories include “food service”, “window cleaning”, and “data/internet”. For instance, if a hospital's GL chart of accounts has been made available and it has been mapped to the known categories in the known vendor database, a comparison between the GL account from the plurality of transaction entries and a potential match of a vendor name. If the account does not match, then the algorithm returns a predetermined score (e.g., 25%). If the account does match then the algorithm returns another predetermined score (e.g., 75%). At block 318, this vendor score may be stored.

As is shown at block 320, a check may be performed to determine if the last of the plurality of transaction entries has been reached for processing. If no, the process continues at block 304. If yes, the process flows to block 322 where the score may be saved if the score is above a predetermined threshold. The process then continues at block 324, where a check may be performed to determine if the last of the plurality of transaction entries has been reached. If not, the process 300 returns to block 302. If yes, the process 300 returns to block 108 of the main process 100. Then main process 100 then flows to completion as discussed above.

Following normalization of the plurality of transaction entries to the common format (e.g., block 104) and before the processing of comparing some or all the plurality of transaction entries to some or all of the plurality of vendor entries (e.g., block 106), a row de-duplication algorithm can be used to reduce the processing time involved with later comparing of the normalized transaction entries to the vendor entries. The transaction entries can be organized into separate rows, such as in the form of separate data entries of an electronic ledger stored in memory. A particular vendor may have multiple entries for different transactions entered in multiple rows, respectively. Each of the entries from the same vendor will have the same normalized name. The row de-duplication algorithm can compare each of the normalized names of all transaction entries to one another to identify exact matches and consolidate those data entries having the same vendor. This row de-duplication algorithm logically iterates through each row and builds a map with the normalized vendor name as a key and memory addresses for the data associated with each data entry (e.g., transaction value, type of service, etc.). As each row is processed by the row de-duplication algorithm, the map is consulted to see if that particular normalized vendor name has already been encountered. If it has not, then that name is added to the map along with that transaction entries' memory address. If it has, then the transaction entries' memory address is added to the memory addresses associated with that normalized vendor name in a map listing.

The output of the row de-duplication algorithm is a map listing which has the minimal set of distinct normalized vendor names, each distinct normalized vendor name associated with a set of memory addresses for the transaction entries associated with the distinct normalized vendor name. As such, the row de-duplication algorithm outputs a map listing having a set of normalized vendor names and memory addresses for all of the transaction entries associating the normalized vendor names with the transaction entries. Some normalized vendor names may be associated with only one transaction entry while some other normalized vendor names may be respectively associated with multiple transaction entries. For example, 20 transactions can be associated with vendor ABC CLEANING while one transaction can be associated with vendor GENERAL INSURANCE). Subsequent comparisons between the transaction entries, as normalized, and the vendor entries to determine the degree of matching between the transaction entries and the vendor entries can comprise comparing the distinct normalized vendor names of the map listing to the vendor entries. A match between one of the normalized vendor names of the map listing and one of the vendor entries can associate each of the transaction entries associated with the normalized vendor name (according to the map listing). For example, if ABC CLEANING as a normalized vendor name is compared to a vendor entry for the same company, then this one comparison can group the 20 transactions associated with this vendor to the vendor entry for this vendor. This is less demanding on the control circuitry than comparing each of the 20 transactions of ABC CLEANING to each of the plurality of vendor entries to make the same grouping.

As noted above, a map/reduce algorithm can be applied in comparing some or all the plurality of transaction entries that have a common vendor name signature/token, either before or during the processing of comparing some or all the plurality of transaction entries to some or all of the plurality of vendor entries (e.g., block 106). More specifically, the map/reduce algorithm can include blocking criteria to separate a plurality of transaction entries and vendor entries into smaller sets in order to reduce the number of pairs of transaction entries and vendor entries which need to be compared to each other. Blocking can occur based on vendor name signatures, although other blocking mechanisms based on other aspects of the names or data are possible. Vendor name signatures are tokens which commonly appear in a subset of the vendor names in both the transactions entries and in the database of known vendors underlying the plurality of vendor entries. Examples of common signatures include “TRUCKING”, “SERVICE”, and “CLEANING”, although there are hundreds of other signatures which appear commonly in the data. The process of filtering and normalizing the vendor names can also provide identification of one or more common signatures that exist in the name.

The use of blocking allows for the map/reduce algorithm to subdivide sets of work to be performed along subgroups. More specifically, the use of blocking creates logical groupings of the plurality of transaction entries and the plurality of vendor entries into subgroups that have common signatures. The plurality of transaction entries and the plurality of vendor entries are then subdivided based on their common signatures to efficiently distribute work to multiple servers. For example, a plurality of subgroups can be distributed to a plurality of computers, respectively, for processing in any manner described herein. This can increase the efficiency of comparing only those transaction entries in a subgroup to those vendor entries in the same subgroup (and not outside of the subgroup) when performing the matching step of block 106, this avoiding unnecessarily comparisons outside of subgroups unlikely to result in matches. More specially, a subgroup of transaction entries and vendor entries may share the common signature of “SHIPPING” and another subgroup of transaction entries may share the common signature of “RECEIVING”. The plurality of transaction entries that are subgrouped based on common signature of “SHIPPING” would not likely match a vendor entry that includes the signature “RECEIVING.” As a result, the map/reduce algorithm would attempt to compare the plurality of transaction entries that share the common signature of “RECEIVING” to the “RECEIVING” vendor entries within a common subgroup in which all entries were previously determined to contain the signature of “RECEIVING”, but would not attempt to compare the group of transaction entries that may share the common signature of “SHIPPING” to the “RECEIVING” vendor entries. Other common signatures may include the vendor name, the beginning letter or letters of the vendor name, and a company indicator in the vendor name. In other embodiments, a general ledger description of the plurality of transactions serves as a signature.

FIG. 4 shows an example of an output from a computer receiving a plurality transaction entries and a plurality of vendor entries in accordance with various embodiments of the present disclosure. The names of the vendors associated with the plurality of transaction entries are normalized and then compared to the names of the vendor entries to group transaction entries with the vendors that performed the work. In FIG. 4, the ten vendors with whom the hospital spent the most money are listed in rows of ascending order. The normalized names of the vendors are listed, as well as the total value of transactions, the % of the total spend of the hospital with the particular vendor, and the total number of transactions are also listed. While ten vendors are listed, it will be appreciated that many more vendors are typically engaged with a hospital and can be listed. The output of FIG. 4 can be printed by a printer (not illustrated) and/or displayed on a screen. This information can help administrators of the hospital identify total or averaged amounts of spend with particular vendors and the quantity of transactions, which can be useful for recognizing the extent of the relationship with each vendor to assist with negotiating service prices.

FIG. 5 shows an example conceptualized drawing illustrating a computer 502 connected to the internet 500 and optionally connected to other computers 506 for use with the process and for storing instructions, consistent with various aspects of the present disclosure. The computer 502 and the other computers 506 can also be connected to a cloud 504. The cloud 504 can provide connectivity and/or data offloading and storage capabilities. In addition, the computer 502 (and the other computers 506) can comprise a single housing or multiple housings among which circuitry can be distributed. The computer 502 (and the other computers 506) can include display circuitry which can provide a graphics output to a screen. Display circuitry can include a graphics processor and graphics memory which can support user interface functionality. Display circuitry may be part of a separate display, such as a screen, handheld device, or remote terminal. As described above, the display of the computer 502 shows a plurality of transaction entries as organized into the plurality of groups (based on the respective degrees of matching between the transaction entries and the vendor entries), and the transaction values, as aggregated, for all transaction entries within the group. This output can be in multiple thousands of rows, and can be useful in displaying, in an organized fashion, a hospital's total purchased services expenditures are organized into logical groupings, a hospital expenditures normalized within each category based on category and hospital-specific metrics, and transaction entries versus industry benchmarks which indicate the relative value that hospitals are receiving from their vendors.

The computer 502 (and the other computers 506) includes processor circuitry 510 and memory circuitry 512 as are known. The memory circuitry 512 can be one or more discrete non-transient computer readable storage medium components (e.g., RAM, ROM, NVRAM, EEPROM, and/or FLASH memory) for storing program instructions and/or data. The processor circuitry 510 can be configured to execute program instructions stored on the memory circuitry to control the computer 502 (and/or the other computers 506) in carrying out the functions referenced herein. The processor circuitry can comprise multiple discrete processing components to carry out the functions described herein as the processor circuitry is not limited to a single processing component or even a single computer. While processor circuitry 510 and memory circuitry 512 are shown in association with the computer 502, it will be understood that other computers 506 can likewise include processor circuitry and memory circuitry. The computer 502 (and the other computers 506) can include a network control circuitry for facilitating communication other remote components.

The techniques described in this disclosure, including those of FIGS. 1-4 and those attributed to a computing system, a processor, and/or control circuitry, and/or various constituent components, may be implemented wholly or at least in part, in hardware, software, firmware or any combination thereof. A processor, as used herein, refers to any number and/or combination of a microprocessor, a digital signal processor (DSP), an application specific integrated circuit (ASIC), a field-programmable gate array (FPGA), microcontroller, discrete logic circuitry, processing chip, gate arrays, and/or any other equivalent integrated or discrete logic circuitry. A “control circuitry” as used herein refers to at least one of the foregoing logic circuitry as a processor, alone or in combination with other circuitry, such as memory or other physical medium for storing instructions, as needed to carry about specified functions (e.g., processor and memory having stored program instructions executable by the processor for normalizing data, associating data entries by determining common portions of data with respect to another data set, and aggregating one or more data fields). The functions referenced herein and those functions of FIGS. 1-4, may be embodied as firmware, hardware, software or any combination thereof as part of a computing system specifically configured (e.g., with programming) to carry out those functions, such as in means for performing the functions referenced herein. The steps described herein may be performed by a single processing component or multiple processing components, the latter of which may be distributed amongst different coordinating devices. In this way, the computing system may be distributed between multiple devices, including part of a camera and part of a computer. In addition, any of the described units, modules, or components may be implemented together or separately as discrete but interoperable logic devices of a computing system. Depiction of different features as modules or units is intended to highlight different functional aspects and does not necessarily imply that such modules or units must be realized by separate hardware or software components and/or by a single device. Rather, functionality associated with one or more modules or units, as part of a computing system, may be performed by separate hardware or software components, or integrated within common or separate hardware or software components of the computing system.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

The following is claimed:

1. A system comprising:
a first database configured to store a first data set that includes a plurality of vendor entries each having multiple data fields including a vendor identifier;
a first circuit configured to receive a second data set that includes a plurality of transaction entries, each transaction entry comprising a plurality of different types of data including a vendor name and a transaction value;
control circuitry configured to:
normalize each of the plurality of transaction entries to a common format by one or both of removing and altering characters from the vendor name,
compare some or all the plurality of transaction entries, as normalized, to some or all of the plurality of vendor entries, respectively;
for each comparison, determine a degree of matching based at least in part on one or more similarities between the vendor identifier of the vendor entry and the vendor name as normalized;
categorize the plurality of transaction entries into a plurality of groups based on the respective degrees of matching between the transaction entries and the vendor entries, the plurality of groups corresponding to the plurality of vendor entries, respectively; and
for each of the plurality of groups, aggregate the transaction values for all transaction entries within the group; and
a user interface configured to display a listing of the plurality of groups and the respective aggregated transaction value of each group.

2. The system of claim 1, wherein the control circuitry is further configured to determine the degree of matching by applying multiple algorithms to each of the transaction entry and the vendor entry that are compared, each algorithm assessing, by a different metric, whether the transaction entry, as normalized, and the vendor entry relate to the same vendor.

3. The system of claim 2, wherein each of the multiple algorithms outputs a vote and the votes of the multiple algorithms are aggregated to determine a degree of matching.

4. The system of claim 3, wherein the control circuitry is further configured to determine, for each transaction entry, a highest degree of matching between the transaction entry and multiple of the vendor entries, and wherein the control circuitry is configured to categorize the transaction entry into the group of the multiple groups that is associated with the vendor entry with which the transaction entry has the highest degree of matching.

5. The system of claim 1, wherein each group of the multiple groups is associated with a single, respective vendor of a plurality of vendors.

6. The system of claim 1, wherein multiple of the transaction entries are categorized into each of the multiple groups.

7. The system of claim 1, wherein the plurality of different types of data of the transaction entries comprise indications of a plurality of different types of services and the plurality of vendor entries comprises indications of the plurality of different types of services, wherein the control circuitry is configured to determine the degree of matching based at least in part on matching or non-matching between the indications of the plurality of different types of services between each of the transaction entry and the vendor entry that are compared.

8. The system of claim 1, wherein the control circuitry is configured to aggregate the transaction values for all transaction entries within each group by calculating a transaction average per at least one of number of beds, average daily census, average daily admissions, number of surgical beds, number of emergency room beds, and square feet of the hospital.

9. The system of claim 1, wherein the control circuitry is further configured to:
define a plurality of subgroups, the plurality of subgroups respectively associated with a plurality of signatures, each of the plurality of signatures indicative of one or both of a respective type of service and a particular vendor name characteristic;
for each of the plurality of transaction entries, assign the transaction entry to one of the plurality of subgroups based on a similarity between at least one of the plurality of different types of data of the transaction entry and the signature associated with the subgroup;
for each of the plurality of vendor entries, assign the vendor entry to one of the plurality of subgroups based on a similarity between the vendor identifier of the vendor entry and the signature associated with the subgroup; and
compare some or all the plurality of transaction entries to some or all of the plurality of vendor entries, respectively, by only comparing those transaction entries to those vendor entries which are assigned to the same subgroup.

10. The system of claim 9, wherein the control circuitry is distributed amongst a plurality of discrete computers each having a respective processor, the subgroups are respectively mapped to the plurality of discrete computers, and the control circuitry is configured to perform the comparing step such that each computer of the plurality of discrete computers performs the comparison only between those transaction entries and vendor entries of the subgroup mapped to the computer.

11. A method comprising:
receiving a plurality of transaction entries, each transaction entry comprising a plurality of different types of data including a vendor name and a transaction value;
normalizing each of the plurality of transaction entries to a common format by one or both of removing and altering characters from the vendor name;
comparing some or all the plurality of transaction entries, as normalized, to some or all of a plurality of vendor entries, respectively, the plurality of vendor entries comprising a listing of known vendors and a plurality of vendor identifiers respectively indicating the known vendors of the listing;
for each comparison, determining a degree of matching based at least in part on one or more similarities between the vendor identifier of the vendor entry and the vendor name as normalized;
categorizing the plurality of transaction entries into a plurality of groups based on the respective degrees of matching between the transaction entries and the vendor entries, the plurality of groups corresponding to the plurality of vendor entries, respectively, and
for each of the plurality of groups, aggregating the transaction values for all transaction entries within the group; and
displaying a listing of the plurality of groups and the respective aggregated transaction value of each group on a user interface, wherein each of receiving, normalizing, comparing, determining, categorizing, and aggregating are performed by control circuitry.

12. The method of claim 11, wherein determining the degree of matching comprises applying multiple algorithms to each of the transaction entry and the vendor entry that are compared, each algorithm assessing, by a different metric, whether the transaction entry, as normalized, and the vendor entry relate to the same vendor.

13. The method of claim 12, wherein each of the multiple algorithms outputs a vote and the votes of the multiple algorithms are aggregated to determine a degree of matching.

14. The method of claim 13, further comprising determining, for each transaction entry, a highest degree of matching between the transaction entry and multiple of the vendor entries, wherein categorizing the plurality of transaction entries comprises categorizing each transaction entry into the group of the multiple groups that is associated with the vendor entry with which the transaction entry has the highest degree of matching.

15. The method of claim 11, wherein each group of the multiple groups is associated with a single, respective vendor of a plurality of vendors.

16. The method of claim 11, wherein multiple of the transaction entries are categorized into each of the multiple groups.

17. The method of claim 11, wherein the plurality of different types of data of the transaction entries comprise indications of a plurality of different types of services and the plurality of vendor entries comprises indications of the plurality of different types of services, and wherein determining the degree of matching is based at least in part on matching or non-matching between the indications of the plurality of different types of services between each of the transaction entry and the vendor entry that are compared.

18. The method of claim 11, wherein aggregate the transaction values for all transaction entries within each group further comprises calculating a transaction average per at least one of number of beds, average daily census, average daily admissions, number of surgical beds, number of emergency room beds, and square feet of the hospital.

19. The method of claim 11, further comprising:
defining a plurality of subgroups, the plurality of subgroups respectively associated with a plurality of signatures, each of the plurality of signatures indicative of one or both of a respective type of service and a particular vendor name characteristic;
for each of the plurality of transaction entries, assigning the transaction entry to one of the plurality of subgroups based on a similarity between at least one of the plurality of different types of data of the transaction entry and the signature associated with the subgroup; and
for each of the plurality of vendor entries, assigning the vendor entry to one of the plurality of subgroups based on a similarity between the vendor identifier of the vendor entry and the signature associated with the subgroup; wherein
comparing some or all the plurality of transaction entries to some or all of the plurality of vendor entries, respectively, comprises only comparing those transaction entries to those vendor entries which are assigned to the same subgroup.

20. The method of claim 19, further comprising mapping the plurality of subgroups to a plurality of discrete computers which form the control circuitry, wherein the comparing step is performed such that each computer of the plurality of discrete computers performs the comparison only between those transaction entries and vendor entries of the subgroup mapped to the computer.
